(19) United States
(12) Patent Application Publication
(10) Pub. No.: US 2025/0166606 A1
(43) Pub. Date: May 22, 2025

(54) Silent speech detection with audio feedback

(71) Applicant: Q (CUE) Ltd., Ramat Gan (IL)

(72) Inventors: Aviad Maizels, Ramat Hasharon (IL); Avi Barliya, Tel-Aviv (IL); Yonatan Wexler, Tel-Aviv (IL); Daniel Kriger, Pardessiya (IL); Avishay Asulin, Rehovot (IL)

(21) Appl. No.: 19/032,536

(22) Filed: Jan. 21, 2025

Related U.S. Application Data
(63) Continuation-in-part of application No. 18/293,806, filed on Jan. 31, 2024.
(60) Provisional application No. 63/229,091, filed on Aug. 4, 2021.
(60) Provisional application No. 63/720,505, filed on Nov. 14, 2024.

(51) Int. Cl. G10L 13/047; G06F 3/01; G10L 15/22

(52) U.S. Cl. CPC G10L 13/047; G06F 3/011; G10L 15/22; G10L 2015/227

(57) ABSTRACT

A system for generating audio feedback to silent speech, the system including a speaker and processing circuitry, the processing circuitry configured to (i) generate speech output including the articulated words of a test subject from sensed movements of skin of a face of the test subject in response to words articulated silently by the test subject and without contacting the skin, (ii) convert the speech output into an audio output, (iii) convey the audio output to the speaker as audio feedback while reducing latency, and (iv) play the audio feedback with reduced latency to the test subject on the speaker.

### CROSS-REFERENCE TO RELATED APPLICATION

This application is a continuation in part of U.S. patent application Ser. No. 18/293,806, filed Jan. 31, 2024, in the national phase of PCT Patent Application PCT/IB2022/054527, filed May 16, 2022, which claims the benefit of U.S. Provisional Patent Application 63/229,091, filed Aug. 4, 2021. This application further claims the benefit of U.S. Provisional Patent Application 63/720,505, filed Nov. 14, 2024. The disclosures of all these related applications are incorporated herein by reference.

### FIELD OF THE INVENTION

The present invention relates generally to physiological sensing, and particularly to algorithms, methods and systems for sensing silent human speech.

### BACKGROUND

In the normal process of vocalization, motor neurons activate muscle groups in the face, larynx, and mouth in preparation for the propulsion of airflow out of the lungs, and these muscles continue moving during speech to create words and sentences. Without this air flow, no sounds are emitted from the mouth. Silent speech occurs when the airflow from the lungs is absent while the muscles in the face, larynx, and mouth continue articulating the desired sounds.

The process of speech activates nerves and muscles in the chest, neck, and face. Thus, for example, electromyography (EMG) has been used to capture muscle impulses for purposes of silent speech sensing.

### SUMMARY

Embodiments of the present invention that are described hereinafter provide a system for generating audio feedback to silent speech, the system including a speaker and processing circuitry, the processing circuitry configured to (i) generate speech output including the articulated words of a test subject from sensed movements of skin of a face of the test subject in response to words articulated silently by the test subject and without contacting the skin, (ii) convert the speech output into an audio output, (iii) convey the audio output to the speaker as audio feedback while reducing latency, and (iv) play the audio feedback with reduced latency to the test subject on the speaker.

In some embodiments, the processing circuitry is configured to reduce latency by achieving 25 mS latency.

In some embodiments, the speaker is included in a wearable device.

In an embodiment, the speaker and the processing circuitry are included in a wearable device.

In some embodiments, the processing circuitry is configured to generate the audio output with the reduced latency by (i) running a feature extraction (FE) algorithm to generate FE output, (ii) inputting the FE output to a neural network (NN) algorithm, (iii) running the NN algorithm to generate speech data output, and (iv) inputting the speech data output to an inter-integrated sound (I2S) interface to generate the audio output with the reduced latency.

In an embodiment, the processing circuitry is included in a wearable device.

In another embodiment, the wearable device includes an earpiece.

In some embodiments, the processing circuitry is configured to convey the audio output to the speaker as audio feedback while reducing latency by using a split architecture system for detecting facial skin micromovements for speech detection, the a split architecture system including (i) a first device configured to perform a first subset of functionalities associated with detecting facial skin micromovements for determining non-vocalized speech, the first device including the circuitry configured to provide audio feedback while reducing latency, and (ii) at least one second device paired with the first device and configured to perform a second subset of functionalities associated with detecting facial skin micromovements for determining non-vocalized speech, in coordination with the first device, and convey the audio output to the speaker as audio feedback while reducing latency.

In an embodiment, the first device includes an earbud.

There is further provided, in accordance with another embodiment of the present invention, a method for generating audio feedback to silent speech, the method including generating speech output including the articulated words of a test subject from sensed movements of skin of a face of the test subject in response to words articulated silently by the test subject and without contacting the skin. The speech output is converted into an audio output. The audio output is conveyed to a speaker as audio feedback while reducing latency. The audio feedback is played with reduced latency to the test subject on the speaker.

The present invention will be more fully understood from the following detailed description of the embodiments thereof, taken together with the drawings in which:

### BRIEF DESCRIPTION OF THE DRAWINGS

FIG. 1 is a schematic pictorial illustration of a system for silent speech detection, in accordance with an embodiment of the invention;

FIG. 2 is a schematic pictorial illustration of a silent speech detection device, in accordance with another embodiment of the invention;

FIG. 3 is a block diagram that schematically illustrates functional components of a system for silent speech detection with audio feedback, in accordance with an embodiment of the invention;

FIG. 4 is a block diagram that schematically illustrates functional components of the audio feedback providing circuitry of FIG. 3, in accordance with an embodiment of the invention;

FIG. 5 is a block diagram that schematically illustrates functional components of a system for silent speech detection with audio feedback, in accordance with another embodiment of the invention; and

FIG. 6 is a block diagram that schematically illustrates functional components of a split architecture system for silent speech detection with audio feedback, in accordance with an embodiment of the invention;

FIG. 7 is a block diagram that schematically illustrates functional components of a split architecture system for silent speech detection with audio feedback, in accordance with another embodiment of the invention; and

FIG. 8 is a flow chart that schematically illustrates a method for silent speech detection with audio feedback, in accordance with an embodiment of the invention.

### DETAILED DESCRIPTION OF EMBODIMENTS

The widespread use of mobile telephones in public spaces creates audio quality issues. For example, when one of the parties in a telephone conversation is in a noisy location, the other party or parties may have difficulty understanding what they are hearing due to background noise. Moreover, use in public spaces often raises privacy concerns, since conversations are easily overheard by passersby.

Silent speech occurs when the airflow from the lungs is absent while the muscles in the face, larynx, and mouth continue articulating the desired sounds. Silent speech can be intentional, for example, when one articulates words but does not wish to be heard by others. This articulation can occur even when one conceptualizes spoken words without opening our mouths. The resulting activation of our facial muscles gives rise to minute movements of the skin surface.

The present disclosure builds on a system for sensing neural activity, the detection focused on the facial region, which allows the readout of residual muscular activation of the facial region. These muscles are involved in inter-human communication, such as the production of sounds, facial expressions (including micro-expressions), breathing, and other signs humans use for inter-person communication.

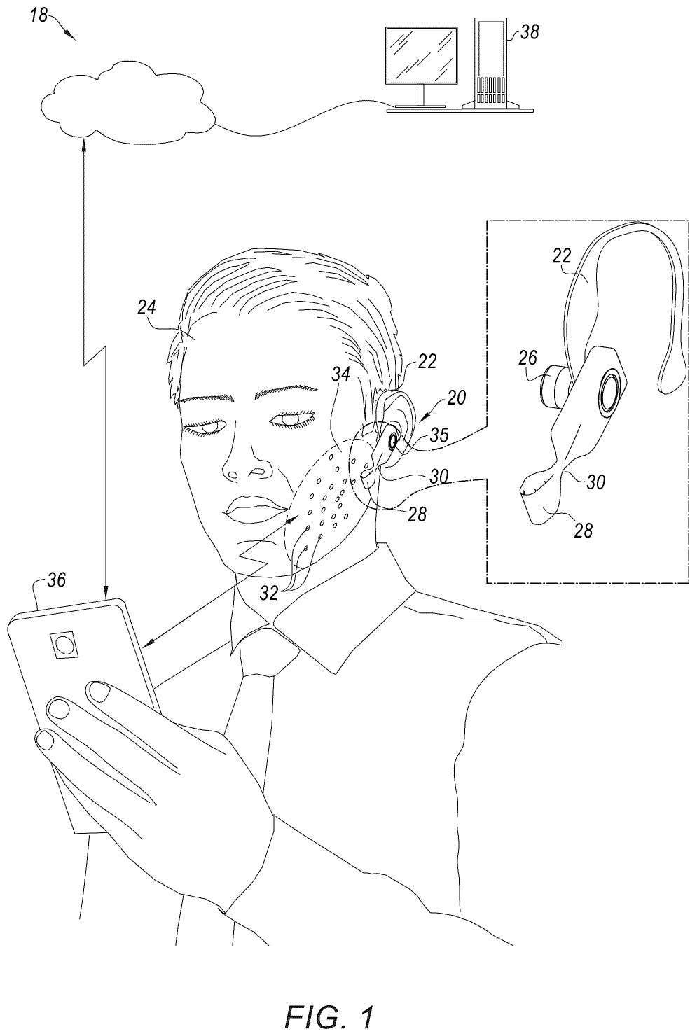

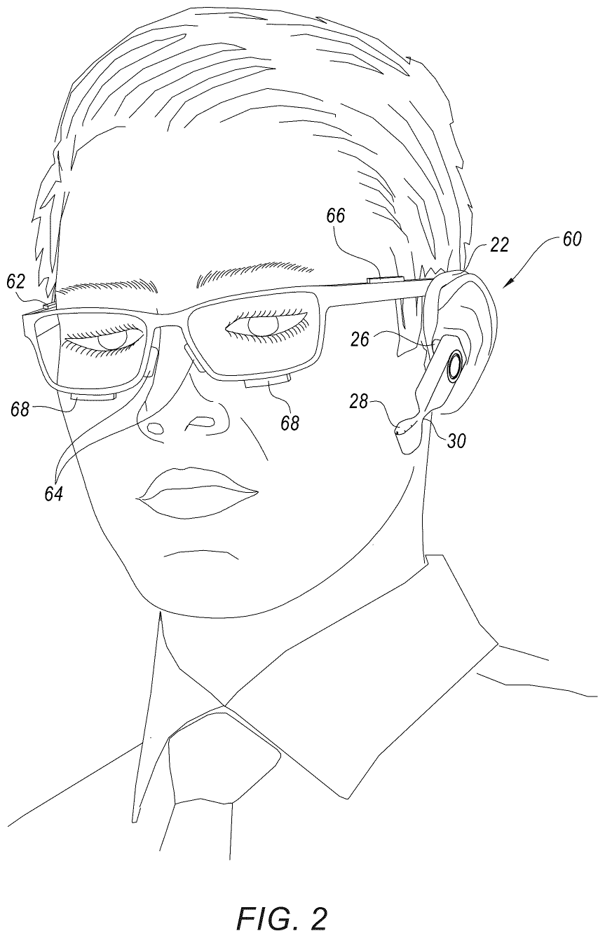

Embodiments of the present invention that are described herein enable users to articulate words and sentences without vocalizing the words or uttering any sounds at all. The inventors have found that properly sensing and decoding these movements using an optical sensing head inside a wearable device (e.g., over the ear, in the ear, or a combination of, as seen in FIGS. 1 and 2 below) makes it possible to reliably reconstruct the actual sequence of words articulated by the user.

In some embodiments, a system includes a wearable device and dedicated software tools that decipher data sensed from fine movements of the skin and subcutaneous nerves and muscles on a subject's face, occurring in response to words articulated by the subject with or without vocalization, and use the deciphered words in generating a speech output including the articulated words. The synthesized audio signal may be transmitted over a network, for example, via a communication link with a mobile communication device, such as a smartphone. Details of devices and methods used in sensing (e.g., detection) the data from fine movements of the skin are described in the above-mentioned International Patent Application PCT/IB2022/054527.

The inventors have further found that providing audio feedback as described in this application gives the user a natural feeling when the user speaks subvocally, by hearing what the speaker said just like the speaker will feel if he were to speak loudly. Audio feedback also gives the user a verification of what the system understood when the user speaks subvocally. The disclosed techniques for silent human speech with audio feedback enable users to communicate naturally with others. To this end, the disclosed technique provides real-time audio feedback to the user (e.g., with 100 mS or less latency).

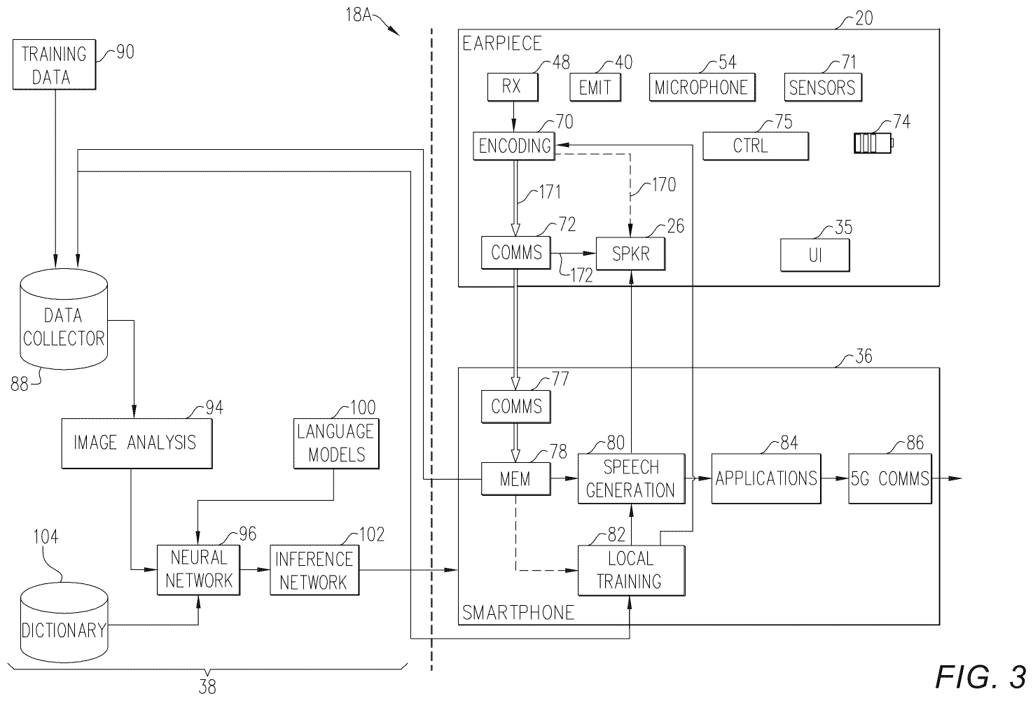

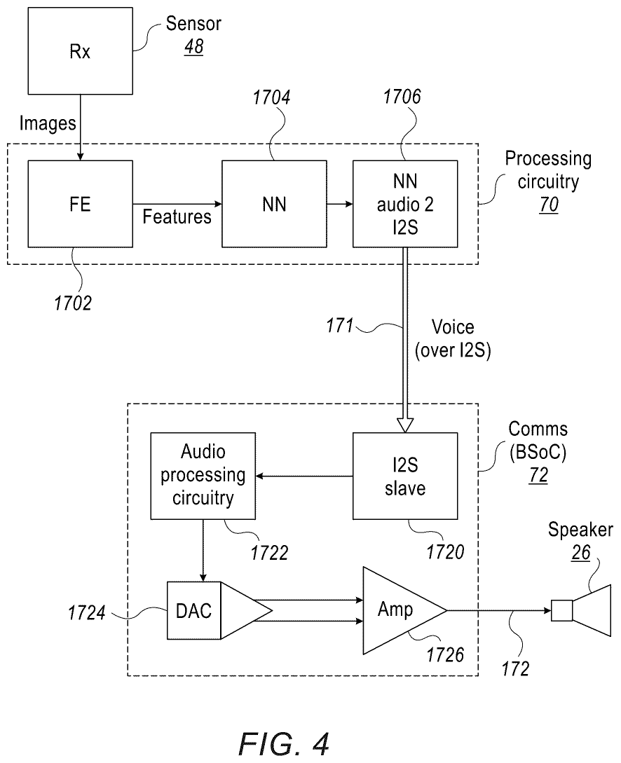

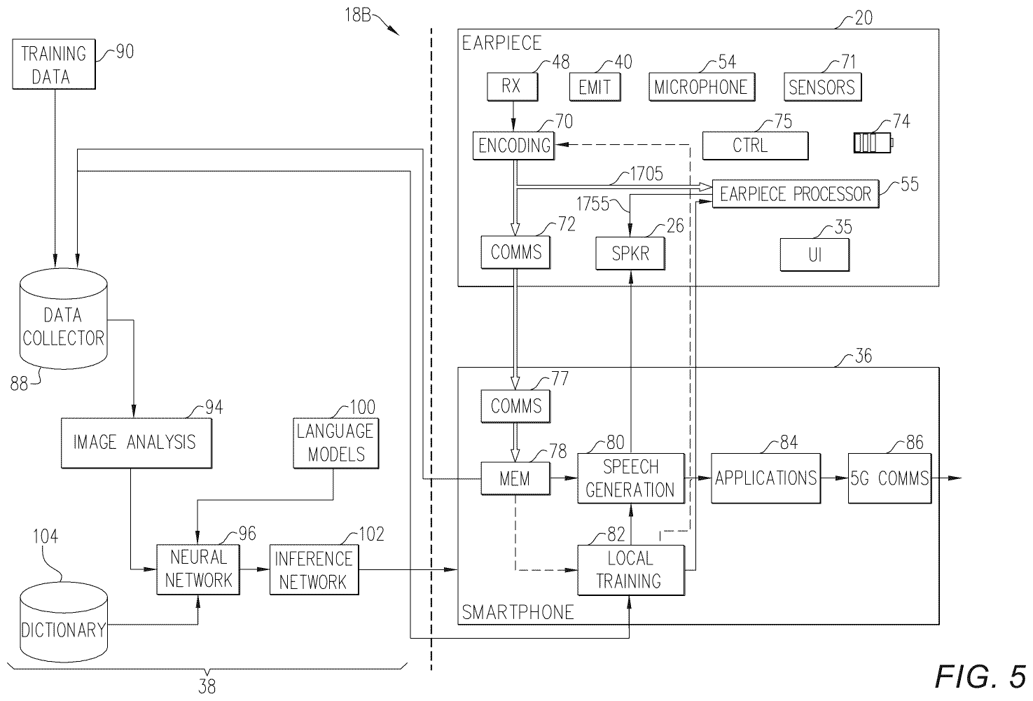

In one embodiment, the disclosed technique has the optical sensing head sense the user's intention to speak/sub-vocal and transfer the data (image) to encoder circuitry in the wearable device. The encoder circuitry takes the image and runs the feature extraction (FE) algorithm to extract the signal and then uses this FE output as an input for a trained neural network (NN) that may also run on the encoder circuitry or another available circuitry in the wearable device, as described in FIG. 3. The NN output is speech data (e.g., words), which is conveyed via an inter-integrated sound (I²S) interface of the wearable device to the speaker in the device as audio feedback at 100 mS or less latency. Details of circuitry implemented in the wearable device described in FIG. 3 that allow the low latency feedback are given in FIG. 4. These details also apply, with the necessary changes have been made (“mutatis mutandis”), to the embodiments shown in FIGS. 5-7.

In another embodiment, described in FIG. 5, the disclosed technique interfaces the optical sensing head of the system with a dedicated earpiece processor inside the wearable device. The processor receives or extracts the features and runs the trained NN to generate speech data (e.g., words). The earpiece processor outputs the words to a Bluetooth system on chip (BSoC) over the I²S interface. The BSoC takes the input of the I²S and feeds it to a sidetone (ST) algorithm controlled by the dedicated processor. The processed audio is mixed with the incoming optical sensor data from the host and feeds into the speaker path, as if a ‘regular’ microphone was used (e.g., over the I²S interface), allowing audio feedback with under a 100 mS latency.

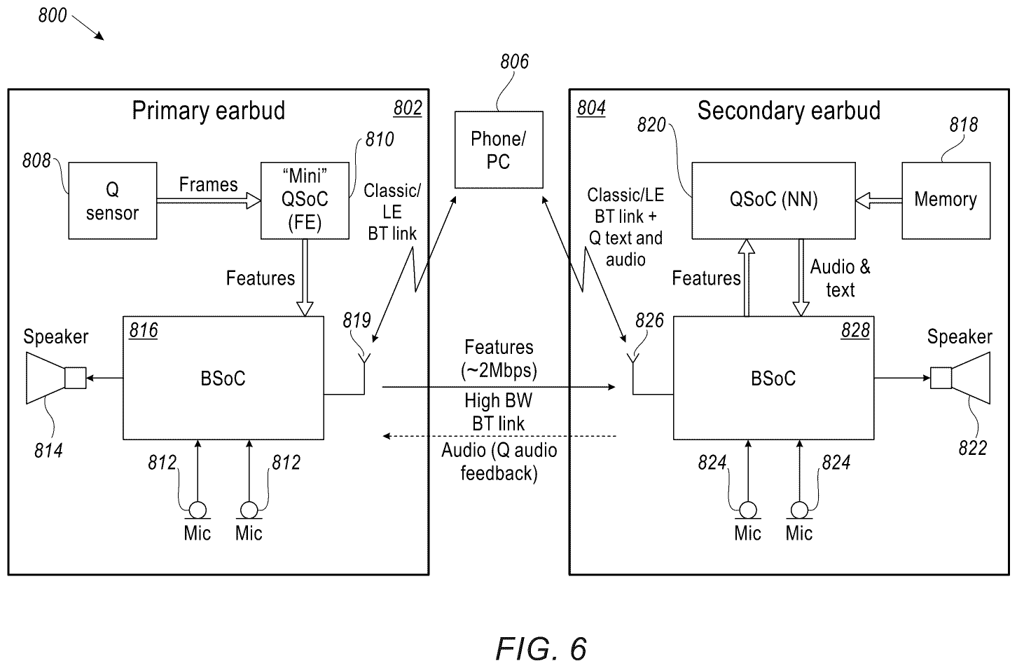

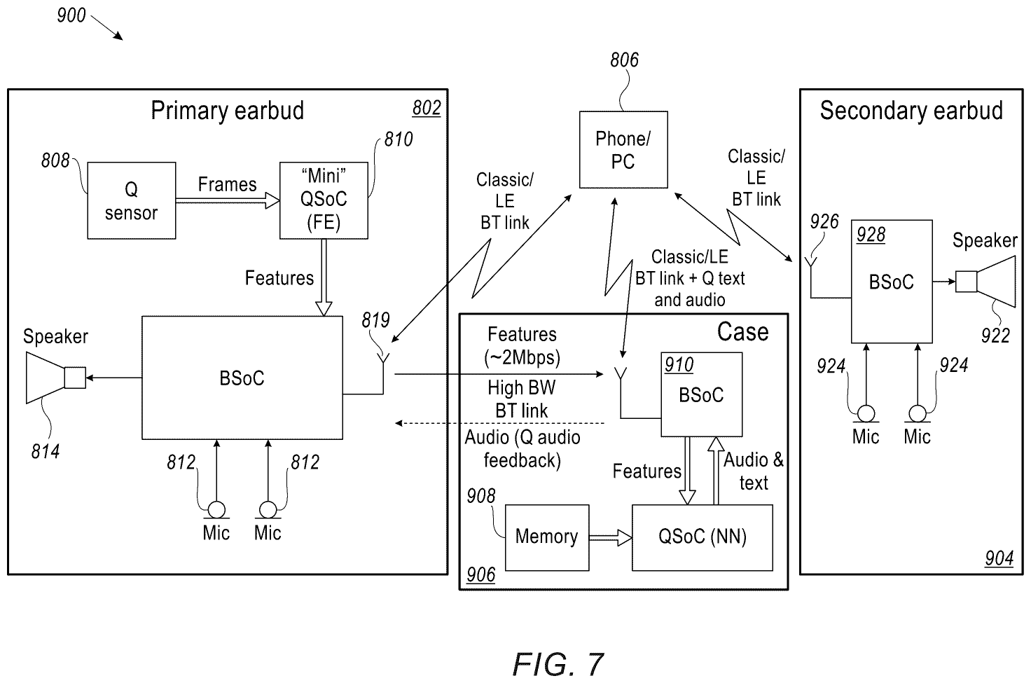

Some of the embodiments for silent human speech with audio feedback are implemented in the split architecture for a pre-vocalized speech recognition system based on sensing facial skin micro-movements described in the aforementioned U.S. Provisional Patent Application 63/720,505. A “split architecture,” examples shown in FIGS. 6 and 7, may refer to a design approach where tasks and/or functions may be divided among multiple components rather than being managed by a single component. In some embodiments, the same type of tasks or functions may be performed by multiple components while in some embodiments, some types of tasks and/or functions may be performed by a first component and a other types of task and/or functions may be performed by one or more second components. More specifically, the split architecture system comprises a first device configured to perform a first subset of functionalities associated with detecting facial skin micromovements for determining non-vocalized speech; and at least one second device paired with the first device and configured to perform a second subset of functionalities associated with detecting facial skin micromovements for determining non-vocalized speech, in coordination with the first device.

The split architecture system may include at least two distinct electronic devices, each performing different sub-sets of operations for sensing facial skin micro-movements to recognize pre-vocalized speech. The at least two devices may communicate using wired and/or wireless means. For example, a first electronic device may perform operations associated with sensing facial skin micromovements, and at least one second electronic device may perform computations for analyzing the sensed facial skin micromovements and determine pre-vocalized speech based on the analysis. For instance, a first earbud (e.g., a first electronic device) may sense facial skin micromovements, and a second earbud (e.g., a second electronic device) may perform computations based on the sensed facial skin micromovements. Distributing the operations thus may reduce the size, cost, and/or heat generated by the first and/or second earbuds. In some instances, one or more processing and/or memory operations may be distributed to additional (e.g., non-wearable) computing resources.

By way of example, the at least one second electronic device may include an earbud paired to one of more of an earbud charging case (e.g., including at least one processor, a memory, and a transceiver), a mobile phone, dedicated hardware (e.g. a compute box), a desktop computer, a laptop computer, a cloud server, and/or any other computing resource. For instance, operations for sensing facial skin micromovements may be allocated to a first earbud, and computations for analyzing the sensed facial skin micromovements and determining pre-vocalized speech may be allocated in a distributed manner between a second earbud, and one or more of an earbud charging case, a mobile communications device, and a cloud server.

The split architecture disclosed herein may enable a smaller form factor for the pre-vocalized speech recognition system. Additional benefits may include improved efficiency in energy consumption by the first and/or at least one second electronic device. The reduced energy consumption may extend the life of one or more batteries associated with the first and/or at least one second devices between charges. Furthermore, performing computation and inference operations using the at least one second electronic device may permit the addition of computational functionalities on an ad hoc basis (e.g., scalable).

A split architecture for a pre-vocalized speech recognition system based on sensing facial skin micromovements may permit smaller-sized and lower-weight devices (e.g., earbuds), while providing the flexibility needed to increase computational capabilities to add functionality, e.g., without replacing hardware components. By removing some hardware components associated with analyzing the sensed facial skin micromovements from the first electronic device (e.g., the first earbud), the first electronic device may be smaller, lighter, and/or more compact. Moreover, transferring and/or distributing the heavier computation and processing operations to the at least one second electronic device may increase the computational capability of the system, and may mitigate computational limitations of the first electronic device, without compromising battery life of the first and/or second electronic device. Moreover, the split architecture may reduce heat dissipation by the first and/or second electronic devices, which may be beneficial for wearable appliances.

In any of the embodiments, the feedback audio quality at the wearable device (e.g., earbud) can be reduced in quality and latency just to let the user the feedback and feel that the user captured what he meant to say, so the audio level should be just sufficient for the user to corroborate his intention. The mobile communication device (e.g., smartphone) circuitry generates high accuracy and audio fidelity audio to be sent out.

The embodiments described above are brought by way of example. As the data processing rate increases with electronics miniaturization and changing architectures (while power consumption falls and batteries improve), other compact realizations (e.g., embodiments) of the audio feedback may be possible, which are covered by this disclosure.

### System Description

FIG. 1 is a schematic pictorial illustration of a system 18 for silent speech detection, in accordance with an embodiment of the invention. System 18 is based on a wearable device 20, in some embodiments, an earpiece 20, in which a bracket, in the form of an ear clip 22, fits over the ear of a user 24 of the device. An earphone 26 (also called hereinafter speaker 26) attached to ear clip 22 fits into the user's ear. An optical sensing head 28 is connected by a short arm 30 to ear clip 22 (e.g., an AirPod) and thus is held in a location in proximity to the user's face. In the pictured embodiment, device 20 has the form and appearance of a clip-on headphone, with the optical sensing head in place of (or in addition to) the microphone.

Optical sensing head 28 directs one or more beams of coherent light toward different, respective locations on the face of user 24, thus creating an array of spots 32 extending over an area 34 of the face (and specifically over the user's cheek). In the present embodiment, optical sensing head 28 does not contact the user's skin at all, but rather is held at a certain distance from the skin surface. Typically, this distance is at least 5 mm, and it may be even greater, for example at least 1 cm or even 2 cm or more from the skin surface. To enable sensing the motion of different parts of the facial muscles, the area 34 covered by spots 32 and sensed by optical sensing head 28 typically has an extent of at least 1 cm²; and larger areas, for example at least 2 cm² or even greater than 4 cm², can be advantageous.

Optical sensing head 28 senses the coherent light reflected from spots 32 on the face and outputs a signal in response to the detected light. Specifically, optical sensing head 28 senses the secondary coherent light patterns that arise due to the reflection of the coherent light from each of spots 32 within its field of view. To cover a sufficiently large area 34, this field of view typically has a wide angular extent, typically with an angular width of at least 60°, or possibly 70° or even 90° or more. Within this field of view, device 20 may sense and process the signals due to the secondary coherent light patterns of all of spots 32 or of only a certain subset of spots 32. For example, device 20 may select a subset of the spots that is found to give the largest amount of useful and reliable information with respect to the relevant movements of the skin surface of user 24.

Within system 18, processing circuitry processes the signal that is output by optical sensing head 28 to generate a speech output. As noted earlier, the processing circuitry is capable of sensing movements of the skin of user 22 and generating the speech output, even without vocalization of the speech or utterance of any other sounds by user 22. The speech output may take the form of a synthesized audio signal or a textual transcription, or both. In that regard, the silent speech detection can be readily implemented as nerve-to-text application, such as, for example, directly transcribing silent speech into an email draft. The synthesized audio signal may be played back via the speaker in earphone 26 (and is useful in giving user 24 feedback with respect to the speech output). Additionally or alternatively, the synthesized audio signal may be transmitted over a network, for example via a communication link with a mobile communication device, such as a smartphone 36. Typically, the synthesis is done at different times than a voiced utterance would happen. This timing can be shorter or longer, and the processer can find the timing difference. Such timing difference may be utilized, as an example, when the synthesized voice is ready earlier than the voiced utterance would happen, to provide a translation of the synthesized voice into another language, with the translated utterance outputted on the time the voiced utterance would.

The functions of the processing circuitry in system 18 may be carried out entirely within wearable device 20, as described in FIG. 3 and, or they may alternatively be distributed between device 20 and an external processor, such as a processor in smartphone 36 running suitable application software, as described in FIG. 4. Details of design and operation embodiments of the processing circuitry are described hereinbelow with reference to FIGS. 3 and 4. Additional details of device 20, such as the data acquisition, interfacing, and processing circuitries comprised in device 20, are described in the above-mentioned International Patent Application PCT/IB2022/054527.

In one example, the processing circuitry within device 20 may digitize, encode the signals output by optical sensing head 28, process the encoded signal to generate the speech output, and transmit the encoded signals to earphone 26 for audio feedback. The processing circuitry within device 20 also transmits the encoded signals over the communication link to smartphone 36 for further processing, if required, and for conversing using smartphone 36 with another human. This communication link may be wired or wireless, for example using the Bluetooth™ wireless interface provided by the smartphone.

In another example, the processing circuitry within device 20 may digitize and encode the signals output by optical sensing head 28 and transmit the encoded signals over the communication link to smartphone 36. This communication link may be wired or wireless, for example, using the Bluetooth™ wireless interface provided by the smartphone. The processor in smartphone 36 processes the encoded signal to generate the speech output. Smartphone 36 may also access a server 38 over a data network, such as the Internet, to upload data and download software updates, for example.

In the pictured embodiment, device 20 also comprises a user control 35, for example, in the form of a push-button or proximity sensor, which is connected to ear clip 22. User control 35 senses gestures performed by user, such as pressing on user control 35 or otherwise bringing the user's finger or hand into proximity with the user control. In response to the appropriate user gesture, the processing circuitry changes the operational state of device 20. For example, user 24 may switch device 20 from an idle mode to an active mode in this fashion and thus signal that the device should begin sensing and generating a speech output. This sort of switching is useful in conserving battery power in device 20. Moreover, a processor or of device 20 can automatically switch from idle mode to high power consumption mode based on differing trigger types, such as a sensed input (e.g., eye blinks or mouth slightly open, or a pre-set sequence of motions like tongue movement). Also, the user may activate the device, using, for example, a touch button on the device, or from an application in a mobile phone.

In an optional embodiment, a microphone (not shown) may be included to sense sound uttered by user 24, enabling user 24 to use device 20 as a conventional headphone when desired. Additionally or alternatively, the microphone may be used in conjunction with the silent speech sensing capabilities of device 20. For example, the microphone may be used in a calibration procedure, in which optical sensing head 28 senses skin movement while user 24 utters certain phonemes or words. The processing circuitry may then compare the signal output by optical sensing head 28 to the sounds sensed by a microphone (not shown) to calibrate the optical sensing head. This calibration may include prompting user 24 to shift the position of optical sensing head 28 to align the optical components in the desired position relative to the user's cheek.

Any of the processing circuitries may include any physical device or group of devices having electric circuitry that performs a logic operation on an input or inputs. For example, the at least one processor may include one or more integrated circuits (IC), including application-specific integrated circuit (ASIC), microchips, microcontrollers, microprocessors, all, or part of a central processing unit (CPU), graphics processing unit (GPU), digital signal processor (DSP), field-programmable gate array (FPGA), server, virtual server, or other circuits suitable for executing instructions or performing logic operations. In some embodiments, the at least one processor may include a remote processing unit (e.g., a “cloud computing” resource) accessible via a communications network.

FIG. 2 is a schematic pictorial illustration of a silent speech detection device 60, in accordance with another embodiment of the invention. In this embodiment, ear clip 22 is integrated with or otherwise attached to a spectacle frame 62. Nasal electrodes 64 and temporal electrodes 66 are attached to frame 62 and contact the user's skin surface. Electrodes 64 and 66 receive body surface electromyogram (sEMG) signals, which provide additional information regarding the activation of the user's facial muscles. The processing circuitry in device 60 uses the electrical activity sensed by electrodes 64 and 66 together with the output signal from optical sensing head 28 in generating the speech output from device 60.

Additionally or alternatively, device 60 includes one or more optical sensing heads 68, similar to optical sensing head 28, for sensing skin movements in other areas of the user's face, such as eye movement. These additional optical sensing heads may be used together with or instead of optical sensing head 28. Device 60 is also configured to provide audio feedback as described, for example, in one of FIGS. 3 and 4 configurations.

### Silent Speech Detection With Audio Feedback

FIG. 3 is a block diagram that schematically illustrates functional components of system 18A for silent speech detection with audio feedback, in accordance with an embodiment of the invention. The pictured system is built around the components shown in FIG. 1, including wearable device 20, smartphone 36, and server 38. A battery 74 provides operating power to the components of wearable device 20.

Optical sensing head 28 of device 20 comprises an optical emitter module 40 and an optical receiver module 48, along with an optional microphone 54. Emitter module 40 comprises a light source, such as an infrared laser diode, which emits an input beam of coherent radiation. Receiver module 48 comprises an array of optical sensors, for example, a CMOS image sensor, with objective optics for imaging area 34. Because of the small dimensions of optical sensing head 28 and its proximity to the skin surface, receiver module 48 has a sufficiently wide field of view, as noted above, and views many of spots 32 at a high angle, far from the normal. Because of the roughness of the skin surface, the secondary speckle patterns at spots 32 can be detected at these high angles, as well.

Microphone 54 senses sounds uttered by user 24, enabling user 24 to use device 20 as a conventional headphone when desired. Additionally or alternatively, microphone 54 may be used in conjunction with the silent speech sensing capabilities of device 20. For example, microphone 54 may be used in a calibration procedure, in which optical sensing head 28 senses skin movement while user 24 utters certain phonemes or words. The processing circuitry may then compare the signal output by the optical sensing head 28 to the sounds sensed by microphone 54 to calibrate the optical sensing head. This calibration may include prompting user 24 to shift the position of optical sensing head 28 to align the optical components in the desired position relative to the user's cheek.

In another embodiment, the audio signals output by microphone 54 can be used in changing the operational state of device 20. For example, the processing circuitry may generate the speech output only if microphone 54 does not detect vocalization of words by user 24. Other applications of the combination of optical and acoustic sensing that is provided by optical sensing head 28 with microphone 54 will be apparent to those skilled in the art after reading the present description and are considered to be within the scope of the present invention.

In the pictured example, wearable device 20 may comprise other sensors 71 (e.g., acoustic sensors), such as electrodes and/or environmental sensors; but as noted earlier, wearable device 20 is capable of operation based solely on non-contact measurements made by the emitter and receiver modules.

Wearable device 20 comprises processing circuitry in the form of an encoder 70 and a controller 75. Encoder 70 comprises hardware processing logic, which may be hard-wired or programmable, and/or a digital signal processor, which extracts and encodes features of the output signal from receiver module 48. Encoder 70 circuitry (or controller 75 circuitry) is coded with an NN software that transforms the encoded features input into words, as detailed in FIG. 4. The words are communicated (171) as a digital signal converted into output audio data by interface circuitry 72 (e.g., I²S circuitry) and conveyed (172) to speaker 26 of wearable device 20 as audio feedback at under a 100 mS latency and preferably 25 mS.

In another embodiment, the functions of Comms block 72 are incorporated into circuitry block 70, and output audio data by interface circuitry (e.g., I²S circuitry) of module 70 is directly conveyed (170) to speaker 26.

In yet another embodiment, the i2S circuitry is connected directly to the speaker. The direct connection may yield lower audio quality, but this quality may be sufficient (as the speaker is already aware of the words silently uttered), while the configuration is highly efficient to realize.

Controller 75 comprises a programmable microcontroller, for example, which sets the operating state and operational parameters of wearable device 20 based on inputs received from a user control 35, receiver module 48, and smartphone 36 (via communication interface 72). As noted above, in some embodiments, controller 75 may comprise a microprocessor and/or a processing array, which processes the features of the output signals from the receiver module 48 locally within wearable device 20 to generate the speech output for audio feedback.

FIG. 4 is a block diagram that schematically illustrates functional components of the audio feedback-providing circuitry of FIG. 3, in accordance with an embodiment of the invention. Specifically, FIG. 4 provides details of blocks 70 and 72 of earpiece 20. As seen, receiver module 48 outputs images (e.g., 2D patterns) to processing circuitry 70 that performs feature extraction (1702) and inputs EF to a NN block 1704. The NN output is speech data (e.g., words), which is conveyed via an inter-integrated sound (I²S) interface 1706 into audio data input to Comms module 72 (that can be implemented as BlueTooth System on Chip (BSoC)). Audio processing circuitry prepares the data received at a slave I²S interface 1720 for real voice generation. To this end, module 1722 comprises an automatic gain control (AGC) module (not shown) and a switch—controlled by the processing circuitry 70 to pass/block audio feedback to the user. The ready digital audio signal is converted by DAC module 1724 into an analog audio signal. An amplifier 1726 amplifies the signal and inputs it to speaker 26 of the earpiece 20. The disclosed circuitry provides the audio feedback with at under a 100 mS latency and with sufficient audio quality for the speaker to confirm his what he spoke silently.

FIG. 5 is a block diagram that schematically illustrates functional components of a system 18B for silent speech detection with audio feedback, in accordance with another embodiment of the invention. In the shown embodiment, an earpiece processor 55 performs one or more of the functionalities of FE, running the NN software and converting the NN output data into audio data by interface circuitry (e.g., I²S circuitry) to convey it to speaker 26 of wearable device 20 as audio feedback at under a 100 mS latency.

In FIG. 5, earpiece processor 55 receives (1705) the features from module 70 and performs functions that in FIG. 3 are performed by at least one of elements 72 or 75, such as running the speech generation. Earpiece processor 55 may also perform the functions of I²S circuitry of module 72 to directly output (1755) audio feedback to speaker 26. As can be understood, other variations of the shown embodiments are possible, such as using processor 55 only for speech generation (e.g., running the NN software).

In the embodiments shown in FIGS. 3 and 5 of wearable devices 20 and 60, which utilize the circuitry of FIG. 4 for audio feedback, the feedback audio quality at wearable devices 20 and 60 (e.g., the earbud or earpiece) is reduced in quality and latency just to let the user the feedback and feel that the user captured the right thing (The user knows what he meant to say, so the audio level should be such sufficient for the user to corroborate his intention). The mobile communication device (e.g., smartphone 36) circuitry generates high accuracy and audio fidelity audio to be sent out.

In the embodiments shown in FIGS. 3 and 5, wearable devices 20 and 60 transmit the audio signals via a communication interface 72, such as a Bluetooth interface, to a corresponding communication interface 77 in smartphone 36. The text and/or audio output from speech generation applications run on one or more of elements 72 and 75 is also input to other applications 84, such as voice and/or text communication applications, as well as a recording application. The communication applications communicate over a cellular or Wi-Fi network, for example, via a data communication interface 86.

In the present example, speech generation application (e.g., an NN) run on one or more of elements 70 and 75 implements an inference network, which finds the sequence of words having the highest probability of corresponding to the encoded signal features received from wearable device 20. Local training interface 82 receives the coefficients of the inference network from server 38, which may also update the coefficients periodically. Local training interface 82 may receive the coefficients by uploading them from a memory 78.

To generate local training instructions by training interface 82, server 38 uses a data repository 88 containing coherent light (e.g., speckle) images and corresponding ground truth spoken words from a collection of training data 90. Repository 88 also receives training data collected from wearable device 20 in the field. For example, the training data may comprise signals collected from wearable device 20 while users articulate certain sounds and words (possibly including both silent and vocalized speech). This combination of general training data 90 with personal training data received from the user of each wearable device 20 enables server 38 to derive optimal inference network coefficients for each user.

Server 38 applies image analysis tools 94 to extract features from the coherent light images in repository 88. These image features are input as training data to a neural network 96, together with a corresponding dictionary 104 of words and a language model 100, which defines both the phonetic structure and syntactical rules of the specific language used in the training data. Neural network 96 generates optimal coefficients for an inference network 102, which converts an input sequence of feature sets, which have been extracted from a corresponding sequence of coherent light measurements, into corresponding phonemes and ultimately into an output sequence of words. Server 38 downloads the coefficients of inference network 102 to smartphone 36 for used in the speech generation application.

Alternatively, the functions illustrated in FIGS. 3 and 5 and described below may be implemented and distributed differently among the components of the system. For example, some or all of the processing capabilities attributed to smartphone 36 may be implemented in wearable device 20; or the sensing capabilities of wearable device 20 may be implemented in smartphone 36.

By way of a non-limiting example, reference is made to FIG. 6, which is a block diagram of a split architecture system 800 for silent speech by detecting facial skin micromovements for speech detection, consistent with some embodiments of the present disclosure. A first device 802 of system 800 is further configured of providing audio feedback with low latency (e.g., under 100 mS).

The system of FIG. 6 includes the first device 802 (or a first electronic device) and a secondary device 804 (or a second electronic device). First device 802 may perform a first subset of functionalities associated with detecting facial skin micromovements for determining non-vocalized speech, and secondary device 804, paired with first device 802, may perform a second subset of functionalities associated with detecting facial skin micromovements for determining non-vocalized speech, in coordination with first device 802. In some embodiments, system 800 may additionally include a third device 806 in communication with first device 802 and with secondary device 804. For example, third device 806 may include a mobile communications device, a laptop computer, a desktop computer, a cloud computer, and/or any other type of computing device. In some embodiments, third device 806 may function as an additional secondary device (e.g., in addition to secondary device 804).

Wearable device 802 comprises processing circuitry 810 and/or 816, which comprises hardware processing logic, which may be hard-wired or programmable, and/or a digital signal processor, which extracts and encodes features of the output signal from receiver module 48. processing circuitry 810 and/or 816 is coded with an NN software that transforms the encoded features input into words, as detailed in FIG. 4. The words are communicated as a digital signal converted into output audio data by am interface circuitry (e.g., I²S circuitry in module 816) and conveyed to speaker 814 of wearable device as audio feedback at under a 100 mS latency.

First device 802, secondary device 804, and optionally third device 806, may communicate via a communications network. In some embodiments, the first electronic device 802 may be a primary earbud, and the second electronic device 804 may be a secondary earbud. In some embodiments, the terms “primary” and “secondary” may refer to a level of usage, reliance, functionality, and/or computational capacity by the user and/or system.

In some disclosed embodiments, first device 802 may include an earbud (e.g., first earbud). In some embodiments, the earbud may include a sensor 808 (e.g., Q optical sensor numbered “48” in FIGS. 4-6). In some embodiments, the sensor may include a system on chip (SoC) 810. For example, an SoC may be an integrated circuit (IC) that consolidates multiple components of an electronic system onto a single physical chip. In some embodiments, the system on chip (SoC) 810 may be a wireless system on chip (SoC). In some embodiments, the wireless SoC is a BlueTooth SoC (e.g., BSoc). In some embodiments, the sensor may include one or more microphones 812.

In the disclosed embodiments, first device 802 includes a speaker 814 for sounding the silent speech audio feedback. In some disclosed embodiments, first device 802 may include, or be associated with, at least one processor 816. In some disclosed embodiments, first device 802 may include a transceiver 819 (e.g., a wireless antenna for communicating with device 806). In some embodiments, a first SoC (e.g., QSoC 810) associated with first device 802 (e.g., a first earbud) may perform operations associated with feature extraction and a second SoC (e.g., QSoC 820) associated with at least one second device 804 (e.g., a second earbud) may perform operations associated with implementing a neural network (e.g., based on the extracted features).

In some disclosed embodiments, at least one secondary device 804 may include an earbud. In some disclosed embodiments, at least one secondary device 804 may include a memory 818, a system-on-chip 820, a speaker 822, and at least one sensor 824 (e.g., one or more microphones). In some disclosed embodiments, secondary device 804 may include a communication apparatus 826 (e.g., including an antenna) configured to transfer data between first device 802 and at least one second device 804. In some disclosed embodiments, communication apparatus 826 may include a wireless system on chip. In some disclosed embodiments, second device 804 may include, or be associated with, at least one processor 828. In some disclosed embodiments, at least one second device 804 may communicate with an additional second device (e.g., third device 806) via a communications network.

Reference is now made to FIG. 7, which is a block diagram of a split architecture system 900 for detecting facial skin micromovements for speech detection, consistent with some embodiments of the present disclosure. System 900 may include first device 802 that provides the audio feedback, and at least one second device. System 900 may be substantially similar to system 800 with the notable difference in that the second device of system 900 may be arranged in an earbud and case configuration (e.g., second earbud 904 paired to case 906) via a network.

Wearable device 802 comprises processing circuitry 810 and/or 816, which comprises hardware processing logic, which may be hard-wired or programmable, and/or a digital signal processor, which extracts and encodes features of the output signal from receiver module 48. processing circuitry 810 and/or 816 is coded with an NN software that transforms the encoded features input into words, as detailed in FIG. 4. The words are communicated as a digital signal converted into output audio data by am interface circuitry (e.g., I²S circuitry in module 816) and conveyed to speaker 814 of wearable device as audio feedback at under a 100 mS latency.

In the embodiment of FIG. 7, electronic components included in second device 804 may be distributed between second earbud 904 and case 906 (e.g., permitting second earbud 904 to be lighter weight and more compact than second earbud 804). For example, case 906 may include a memory 908 and at least one processor 910, and second earbud 904 may include a transceiver 926, at least one microphone 924, a speaker 922, and at least one processor 928. First device 802, second earbud 904, case 906, and optionally third device 806 may communicate via a communications network.

First device 802 may perform a first subset of operations for a first subset of functionalities associated with detecting facial skin micromovements for determining non-vocalized speech, and second device (e.g., earbud 904 and case 906), paired with first device 802, may perform a second subset of operations for a second subset of functionalities associated with detecting facial skin micromovements for determining non-vocalized speech, in coordination with first device 802. In some embodiments, a first SoC (e.g., QSoC 810) associated with first device 802 (e.g., a first earbud) may perform operations associated with feature extraction and at least one second SoC (e.g., QSoC 910) associated with at least one second device 906 (e.g., an earbud case) may perform operations associated with implementing a neural network (e.g., based on the extracted features).

Some disclosed embodiments may provide an option of a high bandwidth channel between the first device and the second device, e.g., to enable additional features. The high bandwidth link may be a one-way link or a two-way link and may include audio compression (e.g., to improve latency). Some disclosed embodiments may provide an option for improved balancing between the first device and second device (e.g., a pair of earbuds). Some disclosed embodiments may provide an option to increase the computational capacity of the split architecture system, e.g., by offloading heavier computational tasks to one or more processors external to the first and second devices. Such processors may be included, for example, in a mobile device and/or cloud server.

In the embodiments shown in FIGS. 6 and 7 of wearable device 802, which utilize the circuitry of FIG. 4 for low-latency audio feedback, the feedback audio quality at wearable device 802 (e.g., the earbud or earpiece) is reduced in quality just to let the user the feedback and feel that the user captured the right thing (The user knows what he meant to say, so the audio level should be such sufficient for the user to corroborate his intention). Another device (e.g., smartphone 806 or case 906) circuitry generates high accuracy and audio fidelity audio to be sent out.

### Method for Speech Detection With Audio Feedback

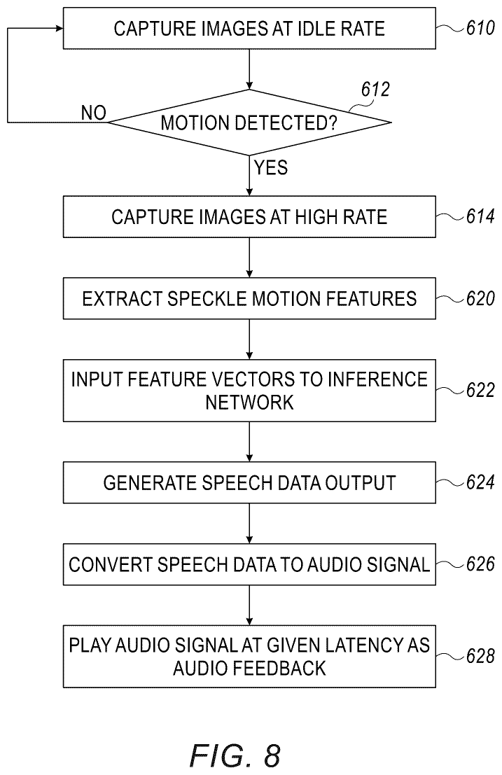

FIG. 8 is a flow chart that schematically illustrates a method for silent speech detection with audio feedback, in accordance with an embodiment of the invention. This method is described, for the sake of convenience and clarity, with reference to the elements of system 18, as shown in FIGS. 1 and 3 and described above. In reference to FIG. 8, all the described steps are performed at the wearable device 20. Alternatively, the principles of this method may be applied in other system configurations, for example, using a sensing device integrated into a mobile communication device that also runs the other steps described in FIG. 8.

As long as user 24 is not speaking, wearable device 20 operates in a low-power idle mode in order to conserve power of its battery, at an idling step 610. This mode may use a low frame rate, for example twenty frames/sec. While device 20 operates at this low frame rate, it processes the images to detect a movement of the face that is indicative of speech, at a motion detection step 612. When such movement is detected, a processor of device 20 instructs to increase the frame rate, for example to the range of 100-200 frames/sec, to enable detection of changes in the secondary coherent light (e.g., speckle) patterns that occur due to silent speech, at an active capture step 614. Alternatively or additionally, the increase the frame rate may follow instructions received from smartphone 36.

Processing circuitry of device 20 then extracts features of optical coherent light pattern motion, at a feature extraction step 620. Additionally or alternatively, the processor may extract other temporal and/or spectral features of the coherent light in the selected subset of spots. Device 20 conveys these features to speech generation application (e.g., trained NN running on one or more of the circuitries 70, 72, of the wearable device 20 in one embodiment, and circuitries 810, 816 of the wearable device 802, at a feature input step 622.

The speech generation application outputs a stream of words, which are concatenated together into sentences, at a speech data output step 624.

Processing circuitry (I²S) of device 20 (or device 802 in case of the disclosed split architecture embodiments) then converts the speech data into an audio signal, at audio conversion step 626.

Finally, the synthesized audio signal is played via speaker 26 (or speaker 814) at a given total latency (e.g., 100 mS) as audio feedback to the user's silent speech, at an audio feedbacking step 628.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A system for generating audio feedback to silent speech, the system comprising:
a speaker; and
processing circuitry, which is configured to:
generate speech output including the articulated words of a test subject from sensed movements of skin of a face of the test subject in response to words articulated silently by the test subject and without contacting the skin;
convert the speech output into an audio output;
convey the audio output to the speaker as audio feedback while reducing latency; and
play the audio feedback with reduced latency to the test subject on the speaker.

2. The system according to claim 1, wherein the processing circuitry is configured to reduce latency by achieving 25 mS latency.

3. The system according to claim 1, wherein the speaker is comprised in a wearable device.

4. The system according to claim 1, wherein the speaker and the processing circuitry are comprised in a wearable device.

5. The system according to claim 1, wherein the processing circuitry is configured to generate the audio output with the reduced latency by:
running a feature extraction (FE) algorithm to generate FE output;
inputting the FE output to a neural network (NN) algorithm;
running the NN algorithm to generate speech data output; and
inputting the speech data output to an inter-integrated sound (I²S) interface to generate the audio output with the reduced latency.

6. The system according to claim 1, wherein the processing circuitry is comprised in a wearable device.

7. The system according to claim 6, wherein the wearable device comprises an earpiece.

8. The system according to claim 1, wherein the processing circuitry is configured to convey the audio output to the speaker as audio feedback while reducing latency by using a split architecture system for detecting facial skin micromovements for speech detection, comprising:
a first device configured to perform a first subset of functionalities associated with detecting facial skin micromovements for determining non-vocalized speech, the first device comprising the circuitry configured to provide audio feedback while reducing latency; and
at least one second device paired with the first device and configured to perform a second subset of functionalities associated with detecting facial skin micromovements for determining non-vocalized speech, in coordination with the first device; and
convey the audio output to the speaker as audio feedback while reducing latency.

9. The system according to claim 8, wherein the first device comprises an earbud.

10. A method for generating audio feedback to silent speech, the method comprising:
generating speech output including the articulated words of a test subject from sensed movements of skin of a face of the test subject in response to words articulated silently by the test subject and without contacting the skin;
converting the speech output into an audio output;
conveying the audio output to a speaker as audio feedback while reducing latency; and
playing the audio feedback with reduced latency to the test subject on the speaker.

11. The method according to claim 10, wherein reducing latency consists of achieving 25 mS latency.

12. The method according to claim 10, wherein the speaker is comprised in a wearable device.

13. The method according to claim 10, wherein the speaker and the processing circuitry are comprised in a wearable device.

14. The method according to claim 10, wherein generating the audio output with the reduced latency comprises:
running a feature extraction (FE) algorithm to generate FE output;
inputting the FE output to a neural network (NN) algorithm;
running the NN algorithm to generate speech data output; and
inputting the speech data output to an inter-integrated sound (I2S) interface to generate the audio output with the reduced latency.

15. The method according to claim 10, wherein generating the speech output, converting the speech output into the audio output, and conveying the audio output to a speaker is performed in a wearable device.

16. The method according to claim 15, wherein the wearable device comprises an earpiece.

17. The method according to claim 10, wherein conveying the audio output to the speaker as audio feedback while reducing latency comprises using a split architecture system for detecting facial skin micromovements for speech detection, comprising:
a first device configured to perform a first subset of functionalities associated with detecting facial skin micromovements for determining non-vocalized speech, the first device comprising the circuitry configured to provide audio feedback while reducing latency; and
at least one second device paired with the first device and configured to perform a second subset of functionalities associated with detecting facial skin micromovements for determining non-vocalized speech, in coordination with the first device; and
convey the audio output to the speaker as audio feedback while reducing latency.

18. The method according to claim 17, wherein the first device comprises an earbud.
